(19) United States
(12) Patent Application Publication
(10) Pub. No.: US 2013/0110362 A1
(43) Pub. Date: May 2, 2013

(54) METHOD FOR PROTECTING DRIVE SHAFT DURING REVERSE SHIFT

(71) Applicant: Seong Hun Hong, Yongin-si (KR)

(72) Inventor: Seong Hun Hong, Yongin-si (KR)

(73) Assignees: Kia Motors Corporation, Seoul (KR); Hyundai Motor Company, Seoul (KR)

(21) Appl. No.: 13/370,650

(22) Filed: Feb. 10, 2012

(30) Foreign Application Priority Data
Oct. 26, 2011 (KR) 10-2011-0109955

(51) Int. Cl. F16H 61/16; G06F 19/00

(52) U.S. Cl. 701/54

(57) ABSTRACT

A method for protecting a drive shaft during a reverse shift, may include a step of determining whether a gear shift of a transmission may be the reverse shift, a step of determining a steering angle while the gear shift may be the reverse shift, a step of detecting an RPM of an engine and determining whether the detected RPM of the engine exceeds a preset RPM while the steering angle corresponds to a full steering, a step of determining a torque that may be applied to the drive shaft when the detected RMP of the engine exceeds the preset RPM, a step of determining whether the torque determined in the torque determination step exceeds a limit torque, and a step of reducing the torque when the determined torque exceeds the limit torque.

### CROSS-REFERENCE TO RELATED APPLICATION

The present application claims priority to Korean Patent Application No. 10-2011-0109955, filed on Oct. 26, 2011 in the Korean Intellectual Property Office, the entire contents of which is incorporated herein for all purposes by this reference.

### BACKGROUND OF THE INVENTION

1. Field of the invention

The present invention relates to a method for protecting a drive shaft through reduction of a driving force during steering on a reverse shift condition, and more particularly, to a method for protecting a drive shaft by limiting a driving force that is applied to a vehicle through reduction of an engine torque during acceleration on a full steering condition while reverse gear shift is performed.

2. Description of Related Art

In general, a steering handle, a steering gear box, a step bar, a knuckle, a lower arm, and wheels are mounted on a chassis device through a connection device, and a drive shaft, which is connected with a bendable joint to transfer outputs of an engine and a transmission, interlocks with the transmission and the chassis device.

On the other hand, since a related art vehicle has a structure in which a shaft joint is bent when steering occurs, a reverse parking condition may be a condition of reverse shift+steering+acceleration (applying of a driving force), and thus, during the steering, the joint on the drive shaft wheel side is bent in interlocking with the direction change of the wheel.

In this case, if excessive torque is input in a full reverse steering state, a secondary moment occurs in the chassis device to cause deformation of a component that connects the chassis device to occur, and thus a compliance steering phenomenon that is an additional steering phenomenon occurs.

On the other hand, according to the joint bending and joint fracture torque characteristics of the drive shaft, a permissible torque becomes smaller as the bending of the point becomes greater when an excessive torque is input during the vehicle steering, and thus the drive shaft may be damaged to deteriorate the safety of the vehicle when the torque is applied in a state where the deformation of the connection component is large.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method for protecting a drive shaft through reduction of a driving force during reverse shift, and particularly to provide a method for protecting a drive shaft by limiting a driving force that is applied to a vehicle through reduction of an engine torque during acceleration on a full steering condition while reverse gear shift is performed.

In one aspect of the present invention, a method for protecting a drive shaft during a reverse shift may include a gear shift determination step of determining whether a gear shift of a transmission is the reverse shift, a steering angle determination step of determining a steering angle while the gear shift is the reverse shift in the gear shift determination step, an RPM (Revolutions Per Minute) determination step of detecting an RPM of an engine and determining whether the detected RPM of the engine exceeds a preset RPM while the steering angle corresponds to a full steering in the steering angle determination step, a torque determination step of determining a torque that is applied to the drive shaft when the detected RMP of the engine exceeds the preset RPM in the RPM determination step, a limit torque determination step of determining whether the torque determined in the torque determination step exceeds a limit torque, and an engine torque reduction step of reducing the torque when the determined torque exceeds the limit torque in the limit torque determination step.

The method for protecting a drive may further include an engine torque maintenance step of maintaining the torque when the determined torque is equal to or smaller than the limit torque in the limit torque determination step.

As described above, according to the present invention, the engine torque is reduced during the acceleration on the full steering condition while the reverse gear shift is performed, and thus the deformation of a chassis system which is connected by various kinds of bushes can be minimized. Further, the fracture strength of the drive shaft joint is secured through reduction of a bending angle of the drive shaft that interlocks with the chassis system, and thus the stability and merchantability of the vehicle can be increased.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a flowchart illustrating a method for protecting a drive shaft during reverse shift according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

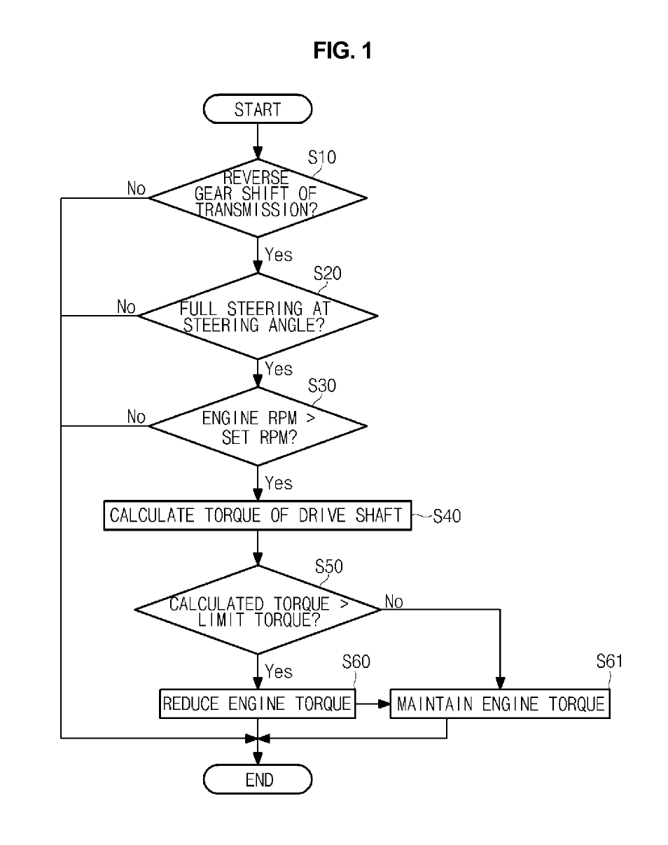

As illustrated in FIG. 1, a method for protecting a drive shaft during reverse shift according to an exemplary embodiment of the present invention includes a gear shift determination step S10 of determining a gear shift of a transmission, a steering angle determination step S20 of determining a steering angle during the reverse shift in the gear shift determination step, an RPM (Revolutions Per Minute) determination step S30 of detecting an RPM of an engine and determining whether the detected RPM of the engine exceeds a preset RPM during full steering at the steering angle in the steering angle determination step, a torque calculation step S40 of calculating torque that is applied to a drive shaft when the detected RMP exceeds the preset RPM in the RPM determination step, a limit torque determination step S50 of determining whether the torque calculated in the torque calculation step exceeds a limit torque, and an engine torque reduction step S60 of reducing the engine torque when the calculated torque exceeds the limit torque in the limit torque determination step.

Hereinafter, constituent elements for the method for protecting a drive shaft during reverse shift according to an exemplary embodiment of the present invention will be described one by one with reference to the accompanying drawing.

First, the method for protecting a drive shaft using reverse shift according to an exemplary embodiment of the present invention basically includes the gear shift determination step, the steering angle determination step, the engine RPM determination step, the torque calculation step, the step of determining whether the calculated torque exceeds the limit torque, and the engine torque reduction step.

As illustrated in FIG. 1, the gear shift determination step S10 is a step of determining the gear shift of the transmission. Whether the gear shift is the reverse shift is confirmed through an inhibited switch of the transmission or a sensor provided on a shift lever. If the gear shift is the reverse shift, the following step proceeds, and if the gear shift is not the reverse shift, logic according to an exemplary embodiment of the present invention is finished.

The steering angle determination step S20 is a step of determining the steering angle if it is confirmed that the gear shift is the reverse shift in the gear shift determination step S10. Whether the steering angle corresponds to the full steering is confirmed through a steering angel sensor that is mounted on a steering wheel. If the steering angle corresponds to the full steering in the reverse gear shift state, the following step proceeds, and if the steering angle does not correspond to the full steering or corresponds to a forward gear shift, the logic according to an exemplary embodiment of the present invention is finished.

In this case, the steering angle range is on a basis of full steering, but it is preferable that the steering angle can be reset according to a vehicle type.

In the RMP determination step S30, if the steering angle corresponds to the full steering in the steering angle determination step S20, the engine RPM of the traveling vehicle is detected, and it is determined whether the detected RPM exceeds the preset RPM. If the RPM of the traveling vehicle exceeds the preset RPM as the result of determination, the following step proceeds, while if the RPM of the traveling vehicle is equal to or smaller than the preset RPM, the logic according to an exemplary embodiment of the present invention is finished.

Of course, when the steering angle corresponds to the full steering, the gear shift is in the reverse gear shift state.

As described above, by determining whether the RPM exceeds the preset RPM on the full steering condition while the reverse gear shift is performed, excessive engine rotation of the traveling vehicle, such as idling caused by a differential gear on an icy road or a non-paved road, is controlled to prevent fracture under impact loading due to driver's breaking.

In other words, even if a driver operates a break in a state where one vehicle wheel is idling on differential condition that the vehicle wheel is lifted up from ground, fracture of the bent drive shaft due to the impact loading that is caused by an abrupt change of the rotating speed is prevented from occurring.

The torque calculation step S40 is a step of calculating the torque that is applied to the drive shaft when the detected RMP exceeds the preset RPM in the RPM determination step S30.

The limit torque determination step S50 is a step of determining whether the torque detected in the torque calculation step S40 exceeds a limit torque. If the torque that is applied to the drive shaft during the full reverse steering exceeds the limit torque, the following step proceeds, while if the torque is equal to or smaller than the limit torque, another step proceeds.

In this case, it is preferable that the limit torque is set to (output torque*gear ratio*0.5), and the output torque is set to (engine torque*torque ratio).

The engine torque reduction step S60 is a step of reducing the engine torque when the torque that is applied to the drive shaft exceeds the limit torque in the limit torque determination step S50. If excessive rotation occurs during the full reverse steering and impact is transferred to the drive shaft, the engine torque is reduced to prevent the damage of the drive shaft due to the impact loading.

On the other hand, if the torque that is applied to the drive shaft is equal to or smaller than the limit torque in the limit torque determination step S50, large impact is not transferred to the drive shaft, and thus it is preferable that the engine torque maintenance step S61 of maintaining the engine torque proceeds.

As described above, the method for protecting the drive shaft during the reverse shift according to an exemplary embodiment of the present invention includes the gear shift determination step of determining the gear shift of the transmission, the steering angle determination step of determining the steering angle during the reverse shift in the gear shift determination step, the RPM determination step of detecting the RPM of the engine and determining whether the detected RPM of the engine exceeds the preset RPM during the full steering at the steering angle in the steering angle determination step, the torque calculation step of calculating the torque that is applied to the drive shaft when the detected RMP exceeds the preset RPM in the RPM determination step, the limit torque determination step of determining whether the torque calculated in the torque calculation step exceeds the limit torque, and the engine torque reduction step of reducing the engine torque when the calculated torque exceeds the limit torque in the limit torque determination step. Accordingly, the engine torque is reduced during the full reverse steering, and thus the deformation of the chassis system which is connected by various kinds of bushes can be minimized. Further, the fracture strength of the drive shaft joint is secured through reduction of the bending angle of the drive shaft that interlocks with the chassis system, and thus the stability and merchantability of the vehicle can be increased.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for protecting a drive shaft during a reverse shift, comprising:
a gear shift determination step of determining whether a gear shift of a transmission is the reverse shift;
a steering angle determination step of determining a steering angle while the gear shift is the reverse shift in the gear shift determination step;
an RPM (Revolutions Per Minute) determination step of detecting an RPM of an engine and determining whether the detected RPM of the engine exceeds a preset RPM while the steering angle corresponds to a full steering in the steering angle determination step;
a torque determination step of determining a torque that is applied to the drive shaft when the detected RMP of the engine exceeds the preset RPM in the RPM determination step;
a limit torque determination step of determining whether the torque determined in the torque determination step exceeds a limit torque; and
an engine torque reduction step of reducing the torque when the determined torque exceeds the limit torque in the limit torque determination step.

2. The method for protecting a drive shaft according to claim 1, further comprising an engine torque maintenance step of maintaining the torque when the determined torque is equal to or smaller than the limit torque in the limit torque determination step.
